(19) United States
(12) Patent Application Publication
(10) Pub. No.: US 2009/0112690 A1
(43) Pub. Date: Apr. 30, 2009

(54) System and method for online advertising optimized by user segmentation

(75) Inventor: Colin Brady, Sunnyvale, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/978,792

(22) Filed: Oct. 29, 2007

(51) Int. Cl. G06F 17/00; G06Q 30/00

(52) U.S. Cl. 705/10; 705/14

(57) ABSTRACT

An improved system and method for online advertising optimized by user segmentation is provided. A segmentation engine may be provided for segmenting a group of users by auctioned advertisements into segments of users and auctioned advertisements for serving users in a segment an ordered list of advertisements in the segment that have been allocated to web page placements for display in an online advertising auction. In response to a search term of a query submitted by a user, an auction engine may serve an ordered list of advertisements for the user's segment for display with results of the query. The click-through rates of advertisements displayed with results of the query may then be tracked for each segment and the list of advertisements for each segment may be ordered based upon updated click-through rates of advertisements belonging to each segment.

### FIELD OF THE INVENTION

The invention relates generally to computer systems, and more particularly to an improved system and method for online advertising optimized by user segmentation.

### BACKGROUND OF THE INVENTION

Sponsored search auctions are a widely used mechanism for selling advertisements using Internet search engines. Each time a user enters a search term into a search engine, a sponsored search auction allocates the advertising space within that user's search results. There are hundreds of millions of separate online sponsored search auctions conducted every day. Search engines' revenues from online sponsored search auctions are on the order of ten billion dollars per year. As a result, these advertising auctions are receiving considerable attention from practitioners and academics. For example, several publications describe on-line algorithms for conducting sponsored search auctions, sometimes with budget constraints such as Abrams, Z., Revenue Maximization When Bidders Have Budgets, In Proceedings the ACM-SIAM Symposium on Discrete Algorithms, 2006. And several publications provide theoretical and empirical analysis of revenue generation in sponsored search markets such as Szymanski, B. and Lee, J., Impact of ROI on Bidding and Revenue in Sponsored Search Advertisement Auctions, Second Workshop on Sponsored Search Auctions, 2006.

However, these analyses of online sponsored search auctions have neglected the role and importance of user behavior for increasing revenue in online sponsored search auctions. Although the importance of increasing click-through rates generated by user selection of auctioned advertisements are generally recognized as fundamental for increasing revenue, there has been a lack of focused analysis on leveraging user information and behavior for increasing revenue in sponsored search markets beyond keywords.

What is needed is a system and method that may optimize revenue in an online advertising auction by leveraging user information and behavior. Such a system and method should be able to respond to changing user behavior in the online advertising auction for optimizing revenue.

### SUMMARY OF THE INVENTION

The present invention provides a system and method for online advertising optimized by user segmentation. A segmentation engine may be provided for segmenting a group of users by auctioned advertisements into segments for serving an ordered list of advertisements allocated to web page placements for display in an online advertising auction. Additionally, one or more segment optimizers may be provided for updating the order of the ordered list of advertisements for each of the segments, and an auction engine may be provided for serving the ordered list of advertisements allocated to web page placements for display in the online advertising auction. In an embodiment for an online advertising auction optimized by user segmentation, the segmentation engine may segment a group of users by auctioned advertisements into clusters of users and auctioned advertisements, and, in response to a search term of a query submitted by a user, an auction engine may serve an ordered list of advertisements for the user's segment for display with results of the query.

To segment a group of users by auctioned advertisements into clusters of users and auctioned advertisements, a list of links to the auctioned advertisements selected by user of the group may be received; the group of users may be clustered into segments by links to the auctioned advertisements selected by the users of the group; the click-through rate for each of the advertisements in each segment may be determined; and the list of advertisement in each segment may be ordered. The click-through rates of advertisements displayed with results of the query may then be tracked for each segment and the list of advertisements for each segment may be reordered based upon updated click-through rates of advertisements belonging to each segment.

The present invention may support many applications for optimizing a list of advertisements for web page placements by user segmentation. For example, online search advertising applications may use the present invention to optimize a list of advertisements selected by user segmentation for web page placements displayed with query results for a user. Or online advertising applications may use the present invention to optimize a list of advertisements selected by user segmentation for web page placements displayed with query results for classes of users. For instance, a class of users may represent a target defined by demographic information including gender, age, or surfing behavior. For any of these applications, online advertisement auctions may optimize a list of advertisements selected by user segmentation for web page placements displayed to a user.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for online search advertising optimized by user segmentation, in accordance with an aspect of the present invention;

FIG. 3 is a flowchart generally representing the steps undertaken in one embodiment for online search advertising optimized by user segmentation, in accordance with an aspect of the present invention;

FIG. 4 is a flowchart generally representing the steps undertaken in one embodiment for clustering a group of users by advertisements to create segments of users to serve advertisements for display, in accordance with an aspect of the present invention;

FIG. 5 is a flowchart generally representing the steps undertaken in one embodiment for updating a list of advertisements to serve for display to users of a segment, in accordance with an aspect of the present invention; and

FIG. 6 is a flowchart generally representing the steps undertaken in one embodiment for query processing in online search advertising optimized by user segmentation, in accordance with an aspect of the present invention.

### DETAILED DESCRIPTION

### Exemplary Operating Environment

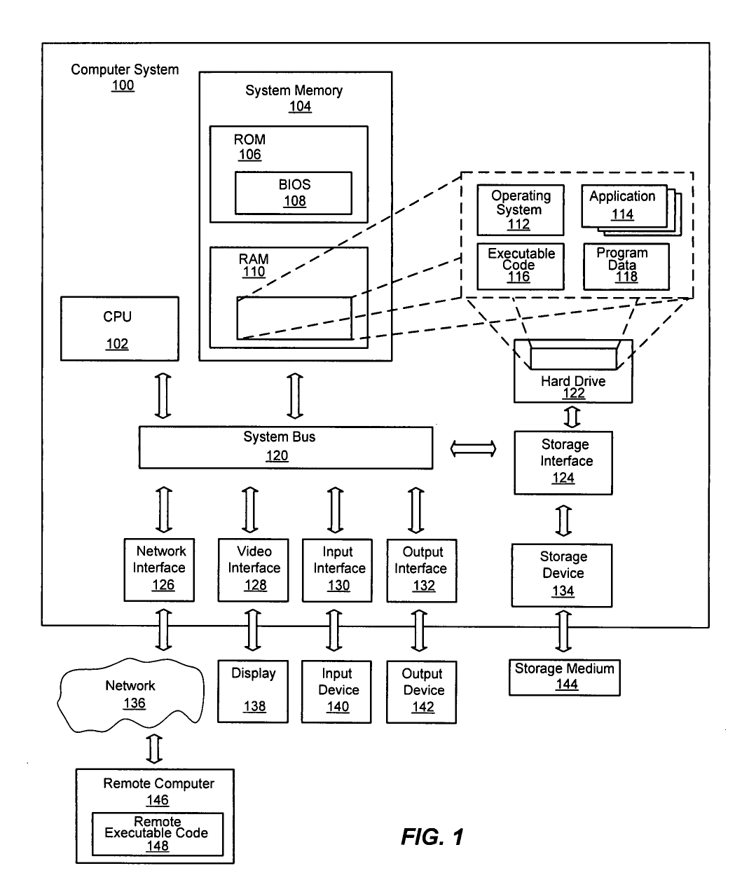

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Online Search Advertising Optimized by User Segmentation

The present invention is generally directed towards a system and method for online advertising optimized by user segmentation. A segmentation engine may be provided for segmenting a group of users by auctioned advertisements into segments for serving an ordered list of advertisements allocated to web page placements for display in an online advertising auction. Additionally, one or more segment optimizers may be provided for updating the order of the ordered list of advertisements for each of the segments, and an auction engine may be provided for serving the ordered list of advertisements allocated to the web page placements for display in the online advertising auction. As used herein, a web page placement may mean a location on a web page designated for placing an advertisement for display. A web page placement may also include additional information such as a target group of visitors to be shown the advertisement. The click-through rates of advertisements displayed may then be tracked for each segment and the list of advertisements for each segment may be ordered based upon updated click-through rates of advertisements belonging to each segment.

As will be seen, the present invention may support many applications for optimizing a list of advertisements for web page placements by user segmentation. For example, online search advertising applications may use the present invention to optimize a list of advertisements selected by user segmentation for web page placements displayed with query results for a user. As will be understood, the various block diagrams, flow charts and scenarios described herein are only examples, and there are many other scenarios to which the present invention will apply.

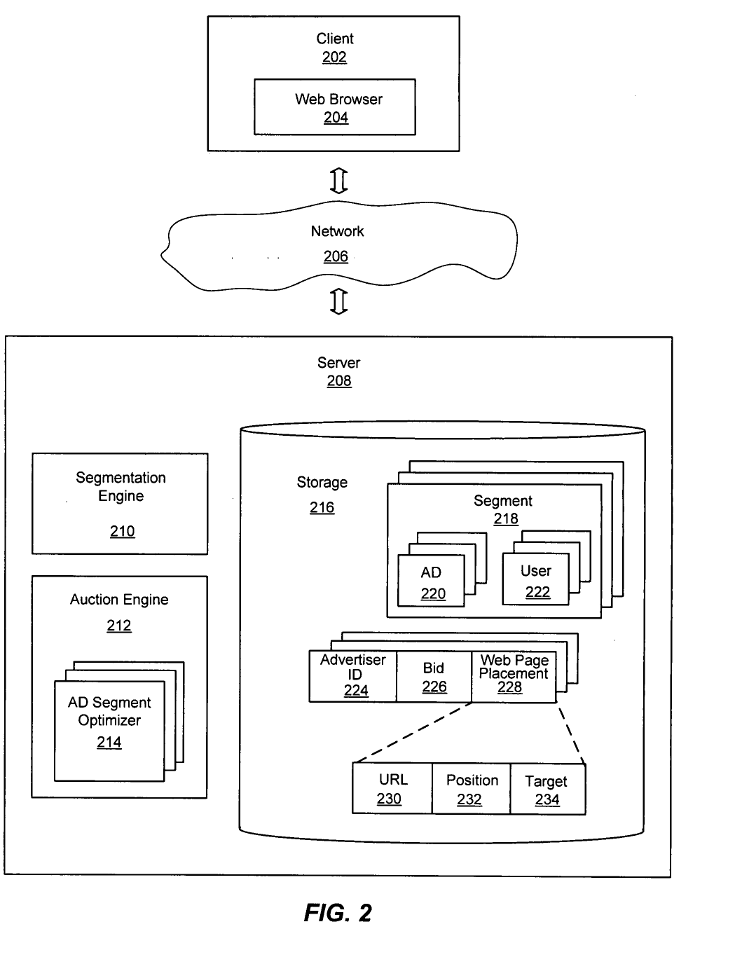

Turning to FIG. 2 of the drawings, there is shown a block diagram generally representing an exemplary architecture of system components for online search advertising optimized by user segmentation. Those skilled in the art will appreciate that the functionality implemented within the blocks illustrated in the diagram may be implemented as separate components or the functionality of several or all of the blocks may be implemented within a single component. For example, the functionality for the segmentation engine 210 may be included in the same component as the auction engine 212. Or the functionality of the advertisement segment optimizer 214 may be implemented as a separate component from the auction engine 212. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include services for providing a list of auctioned advertisements to accompany the search results of query processing. In particular, the server 208 may include a segmentation engine 210 for grouping users by advertisements, and an auction engine 212 for providing a list of auctioned advertisements to accompany search results. The auction engine 212 may include an advertisement segment optimizer 214 for updating the ordering of the list of advertisements for a particular segment. Each of these modules may also be any type of executable software code such as a kernel component, an application program, a linked library, an object with methods, or other type of executable software code.

The server 208 may be operably coupled to a database of information such as storage 216 that may include segments 218 of any type of advertisements 220 and users 222. Each advertisement 220 may be associated with an advertisement ID 224. In an embodiment, a bid 226 may be associated with an advertisement ID 224 for one or more advertisements 220 to be displayed according to the web page placement 228. The web page placement 228 may include a Uniform Resource Locator (URL) 230 for a web page, a position 232 for displaying an advertisement on the web page, and a target ID 234 for referencing a target or group of visitors that may be defined by a profile of characteristics that may match a visitor of the web page. In various embodiments, a target may be defined by demographic information including gender, age, or surfing behavior. The segmentation of grouping users by advertisements may be behavioral in various embodiments and may co-exist with existing segmentation methods including demographic-based. Any type of advertisements 220 may be associated with an advertisement ID 224. Advertisers may have multiple advertiser IDs 224 representing several bid amounts for various web page placements.

There may be many applications which may use the present invention for optimizing a list of advertisements for web page placements by user segmentation. For example, online search advertising applications may use the present invention to optimize a list of advertisements selected by user segmentation for web page placements displayed with query results for a user. Or online advertising applications may use the present invention to optimize a list of advertisements selected by user segmentation for web page placements displayed with query results for classes of users. For instance, a class of users may represent a target defined by demographic information including gender, age, or surfing behavior. For any of these applications, online advertisement auctions may optimize a list of advertisements selected by user segmentation for web page placements displayed with query results.

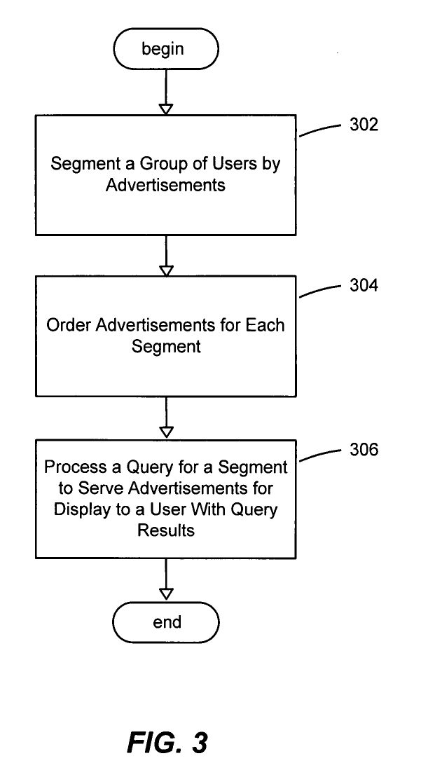

FIG. 3 presents a flowchart for generally representing the steps undertaken in one embodiment for online search advertising optimized by user segmentation. At step 302, a group of users may be segmented by advertisements. For example, a group of users may be clustered in an embodiment based upon click-through rates of selected links to advertisements or conversion rates of selected links to advertisements. As used herein, conversion rates mean acceptance or purchase of goods or services. In various other embodiments, groups of users may be clustered based upon user information such as user click-through rates for sponsored search advertisements and demographic information including gender, age, or surfing behavior. In any case, the segmentation of grouping users by advertisements may be behavioral in various embodiments and may co-exist with existing segmentation methods including demographic-based. At step 304, advertisements may be ordered for each segment. In an embodiment, there may be a separate optimizer instantiated for ordering advertisements for each segment of users. The advertisements may be initially ordered by click-through rates for sponsored search advertising when the segments of users may be created and then reordered as click-through rates may change from user selection within the segment for advertisements served for display to users of the segment with query results.

Once a group of users may be segmented by advertisements and advertisements may be ordered for each segment, a query may be processed at step 306 from a user of a segment to serve a list of advertisements for display to the user of the segment with query results. In an embodiment, there may be an advertisement in the list of advertisements served for each web page placement available for display with query results.

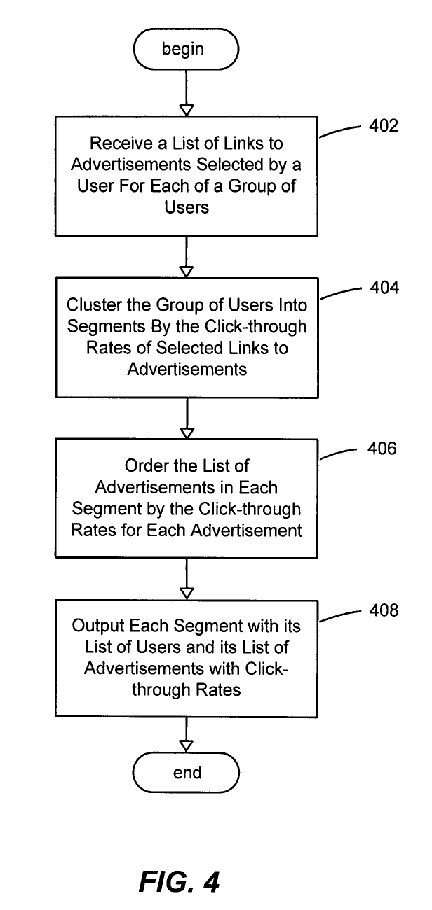

FIG. 4 presents a flowchart generally representing the steps undertaken in one embodiment for clustering a group of users by advertisements to create segments of users to serve advertisements for display. At step 402, a list of links to advertisements selected by a user may be received for each user of a group of users. At step 404, the group of users may be clustered into segments by the links to advertisements selected by each of the users. In an embodiment, the group of users may be clustered into segments based on the click-through rates of the links to advertisements selected by each user. The click-through rate for web page placements for each advertisement may be determined in an embodiment from historical data of tracked click-through rates. In another embodiment, the click-through rate for each advertisement may be determined by estimating the click-through rate from revenue received. In any case, each of the users in each of the segments may be tagged with an identification of the segment so that users in the same segment may be routed to an optimizer for that segment so that the optimizer may note advertisement selection by tracking click-throughs by users in the segment and optimize the ordering of the list of advertisements served to users of the segment. At step 406, the list of advertisements in each segment may be ordered by the click-through rates of advertisements in each segment. At step 408, the list of users and the list of links to advertisements with click-through rates for each advertisement may be output for each segment.

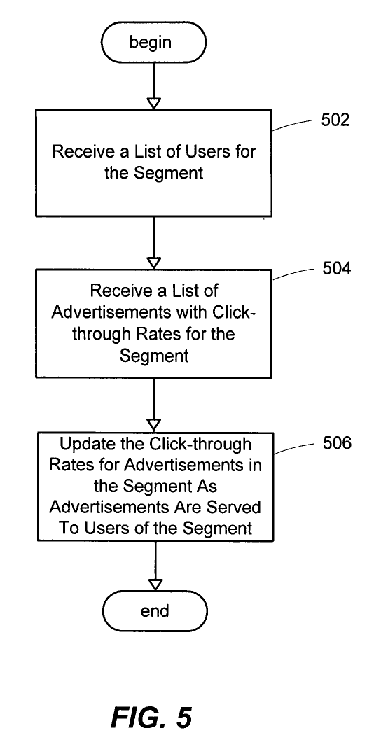

FIG. 5 presents a flowchart generally representing the steps undertaken in one embodiment for updating a list of advertisements to serve for display to users of a segment. At step 502, a click may be received from a user in a segment for an advertisement in the segment. At step 504, a list of advertisements with click-through rates may be received for the segment. In an embodiment, the list of advertisements used to group the list of users may also be received. Together, the list of users and the list of advertisements used to group the users may define each segment. At step 506, the click-through rates for each of the list of advertisements belonging to the segment may be updated as advertisements may be served to users belonging to the segment. In an embodiment, the user's interaction with the served ads may be recorded and used to adjust the ad's click-through rates.

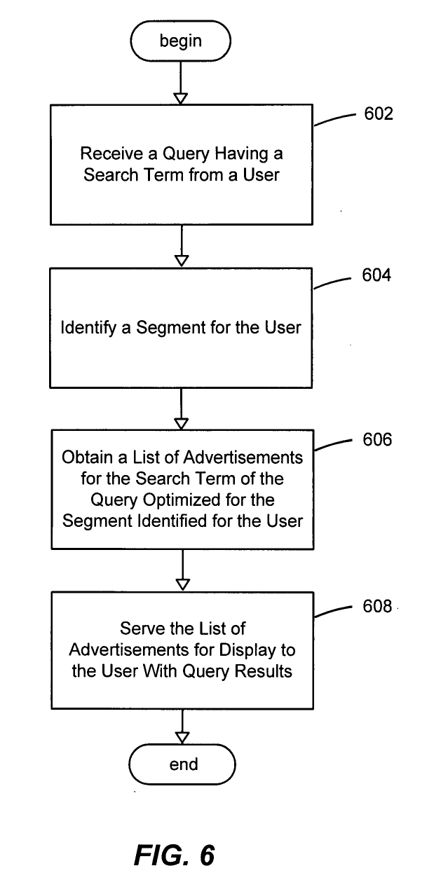

FIG. 6 presents a flowchart for generally representing the steps undertaken in one embodiment for query processing in online search advertising optimized by user segmentation. The segments of users and advertisements generated by segmenting the users by advertisements may be stored in storage such as storage 216 illustrated in FIG. 2 for use by an advertisement server. A query having a search term may be received at step 602 from a user, and a segment may be identified at step 604 for the user. In an embodiment, each of the users in each of the segments may be tagged with an identification of the segment in order to route a user in a segment to an optimizer for that segment so that the optimizer may obtain a list of advertisements to serve to users of the segment. In various embodiments, an optimizer may optimize the ordering of the list of advertisements served to users of the segment as users of the segment select advertisement served to users of the segment.

A list of advertisements may be obtained at step 606 for the search term of the query optimized for the segment identified for the user. And the list of advertisements may be served at step 608 for display to the user with the query results.

Thus the present invention may leverage user behavior and/or user information to increase revenue in online sponsored search auctions. Advantageously, the system and method is able to respond to changing user behavior in the online advertising auction by tracking and updating the click-through rates of auction advertisements served to users of a segment, and then reordering the list of advertisements for the segment based upon updated click-through rates of advertisements belonging to the segment. In addition to increasing revenue, responding to changing user behavior in the online advertising auction may also improve the user experience in applications such as sponsored search.

As can be seen from the foregoing detailed description, the present invention provides an improved system and method for online advertising optimized by user segmentation. A segmentation engine may segment a group of users by auctioned advertisements into clusters of users and auctioned advertisements. And, in response to a search term of a query submitted by a user, an auction engine may serve an ordered list of advertisements for the user's segment for display with results of the query. The click-through rates of advertisements displayed with results of the query may then be tracked for each segment and the list of advertisements for each segment may be reordered based upon updated click-through rates of advertisements belonging to each segment. Many applications may use the present invention for optimizing a list of advertisements for web page placements by user segmentation, including online search advertising applications for displaying a list of advertisements with query results for a user. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for an online advertising auction, comprising:
a segmentation engine for segmenting a plurality of users by a plurality of advertisements into a plurality of segments for serving an ordered list of advertisements allocated to a plurality of web page placements for display in an online advertising auction; and
a storage operably coupled to the segmentation engine for storing the plurality of segments each having a cluster of the plurality of users and a cluster of the plurality of advertisements for allocating to web page placements in the online advertising auction.

2. The system of claim 1 further comprising an auction engine for providing the ordered list of advertisements allocated to the plurality of web page placements for display in the online advertising auction.

3. The system of claim 2 further comprising a plurality of advertisement segment optimizers, each operably coupled to the auction engine for updating the order of the ordered list of advertisements for each of the plurality of segments.

4. A computer-readable medium having computer-executable components comprising the system of claim 1.

5. A computer-implemented method for an online advertising auction, comprising:
receiving a query having a search term from a user of a plurality of users segmented by a plurality of advertisements auctioned in an online advertising auction;
identifying a segment for the user;
obtaining a list of advertisements ordered for the segment identified for the user in the online advertising auction; and
outputting the list of advertisements for display to the user with results of the query.

6. The method of claim 5 further comprising segmenting the plurality of users by the plurality of advertisements auctioned in the online advertising auction.

7. The method of claim 6 wherein segmenting the plurality of users by the plurality of advertisements auctioned in the online advertising auction comprises receiving a list of links to the plurality of advertisements selected by at least one of the plurality of users.

8. The method of claim 6 wherein segmenting the plurality of users by the plurality of advertisements auctioned in the online advertising auction comprises clustering the plurality of users into a plurality of segments by links to the plurality of advertisements selected by the plurality of users.

9. The method of claim 6 wherein segmenting the plurality of users by the plurality of advertisements auctioned in the online advertising auction comprises determining the click-through rate for each of the plurality of advertisements.

10. The method of claim 6 wherein segmenting the plurality of users by the plurality of advertisements auctioned in the online advertising auction comprises clustering the plurality of users into a plurality of segments by user information and by links to the plurality of advertisements selected by the plurality of users.

11. The method of claim 6 wherein segmenting the plurality of users by the plurality of advertisements auctioned in the online advertising auction comprises tagging each of the plurality of users with an identification of a segment.

12. The method of claim 5 further comprising ordering the list of advertisements for the segment identified for the user in the online advertising auction.

13. The method of claim 5 further comprising updating the click-through rates for auctioned advertisements selected by a plurality of user in the segment.

14. The method of claim 5 further comprising reordering the list of advertisements for the segment identified for the user in the online advertising auction by click-through rates updated from selection of auctioned advertisements by a plurality of user in the segment.

15. The method of claim 5 wherein outputting the list of advertisements for display to the user with results of the query comprises sending the list of advertisements allocated web page placements in the online advertising auction to a client device for display.

16. The method of claim 5 wherein outputting the list of advertisements for display to the user with results of the query comprises tracking the click-through rates of advertisements allocated web page placements in the online advertising auction by the plurality of users in the plurality of segments.

17. A computer-readable medium having computer-executable instructions for performing the method of claim 5.

18. A computer system for an online advertising auction, comprising:
means for receiving a search term from a user of a plurality of users segmented by a plurality of advertisements auctioned in an online advertising auction;
means for identifying a segment for the user; and
means for obtaining a list of advertisements ordered for the segment identified for the user in the online advertising auction.

19. The computer system of claim 18 further comprising means for outputting the list of advertisements for display to the user with results of the query.

20. The computer system of claim 18 further comprising means for segmenting the plurality of users by the plurality of advertisements auctioned in the online advertising auction.
